(19) United States
(12) Patent Application Publication
(10) Pub. No.: US 2020/0394736 A1
(43) Pub. Date: Dec. 17, 2020

(54) SYSTEM AND METHODS FOR SELECTING AT LEAST ONE PREFERRED EDUCATION INSTITUTION

(71) Applicant: Corsava, LLC, Seattle, WA (US)

(72) Inventors: Anne R. Wager, Seattle, WA (US); Robert Chong, Houston, TX (US); Ernie Booth, Seattle, WA (US)

(21) Appl. No.: 16/789,305

(22) Filed: Feb. 12, 2020

Related U.S. Application Data
(63) Continuation-in-part of application No. 16/531,459, filed on Aug. 5, 2019.
Application No. 16/531,459 is a continuation of application No. 15/583,924, filed on May 1, 2017, now abandoned.
(60) Provisional application No. 62/804,299, filed on Feb. 12, 2019.
(60) Provisional application No. 62/331,009, filed on May 3, 2016.

(51) Int. Cl. G06Q 50/20; G06F 16/22; G06F 16/2457

(52) U.S. Cl. CPC G06Q 50/2053; G06F 16/24578; G06F 16/2282

(57) ABSTRACT

a system and method for providing students with a “best college fit” by considering and weighting data and metadata provided by students and/or parents, subject matter experts, and third-party (or open source) data bases. Further, the disclosed invention allows students to act as their own “oracles” updating the best college fit as data is improved.

### CROSS-REFERENCES TO RELATED APPLICATIONS

This application takes priority to U.S. Provisional Application 62/804,299, filed on Feb. 12, 2019, currently pending, and is a continuation-in part of U.S. application Ser. No. 16/531,459, filed on May 1, 2019, currently pending. U.S. application Ser. No. 16/531,459 is a continuation of U.S. application Ser. No. 15/583,924, filed on May 2, 2017, now abandoned. US Application takes priority to U.S. Provisional Application 62/331,009, filed on May 3, 2016.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND

Every year, hundreds of thousands of students search for the college, university, or other educational institution (hereinafter referred to singularly or together as “educational institution”) that will best fit their needs. Most of these students contact a counselor, either private or public, to help them through this process. Both counselors and students may feel overwhelmed by the process.

Counselors may feel that they do not have enough time to spend with each student. Most counselors have no budget or time to do the research that is required to stay up-to-date on the programs and qualities each college offers. Some counselors use websites, guidebooks, or even their own notes when advising students. It is difficult for counselors to keep track of this information. Existing software solutions are expensive and, in some cases, try to replace the guidance that can only be provided by a trained counselor. Additionally, software solutions may not provide up-to-date information or they are too cumbersome.

Most students cannot afford to hire a private counselor who can advise the student on college choices. Students may not have vetted online resources to rely on. Many online resources are not trustworthy or are sponsored. Some students may receive unsolicited informational bulletins or pamphlets from colleges which simply confuse the students. Some students may not know how to build a college list, how to compare colleges, or even what they want out of a college. Some students may not know how to connect with colleges; the process may be overwhelming and intimidating. Some families end up relying on college rankings to make college choices without a real understanding of whether the college is suited to the student. And, in some cases, parents may not have any productive way to get involved in the process to choose a college.

US Publication 20060069576 (hereinafter “Waldorf”), teaches gathering survey information from students and matching that information with the colleges that most closely provide attributes of students' survey results. Qualitative information about colleges is provided by college counselors. Matching colleges are checked for accuracy by “experts in college placement”. Students may also review matching colleges for accuracy. Waldorf's abandoned application is a simple recommender system.

Recommender systems typically produce a list of recommendations in one of two ways—through collaborative filtering or through content-based filtering (also known as the personality-based approach). Collaborative filtering approaches build a model from a user's past behavior (items previously purchased or selected and/or numerical ratings given to those items) as well as similar decisions made by other users. This model is then used to predict items (or ratings for items) that the user may have an interest in. Content-based filtering approaches utilize a series of discrete characteristics of an item in order to recommend additional items with similar properties. These approaches may be combined. This system for determining a best college fit is lacking because it is heavily reliant on survey and cohort data which, by itself, is unreliable.

US Publication 2015/0066559 (hereinafter “Brouwer”) teaches a system that provides information to students that is “not biased toward a particular university choice, and which does not rank possible sections for students.” Brouwer, paragraph [0010]. Brouwer's teaches a system that provides students with information that is provided by colleges and universities. Unfortunately, this information by itself cannot tell a student whether a college is a good fit for the student.

US Publication 2009/0081629 (hereinafter Billmeyer) teaches a scoring algorithm that “meets the goal of preferring ‘moderation” . . . ” Billmeyer, paragraph [0063]. Billmeyer teaches that the moderate match is accomplished by using the Cobb-Douglass Algorithm. Billmeyer, paragraph [0064].

The art discussed above does not consider all data available to help students determine a best college fit. For example, Waldorf does not consider information about the data (metadata). Although both Waldorf and Brouwer discuss the value of college counselors after information is provided to students, neither consider the value of the information college counselors can provide in to determine the best college fit. Further, neither Waldorf or Brower consider how third-party data should be weighted or related to other data so at to determine a best college fit.

### BRIEF DESCRIPTION OF INVENTION

The invention disclosed herein provides for a system and method for providing students with a “best college fit” by considering and weighting data and metadata provided by students and/or parents, subject matter experts, and third-party (or open source) data bases. Further, the disclosed invention allows students to act as their own “oracles” updating the best college fit as data is improved.

### DESCRIPTION OF THE SEVERAL VIEWS OF THE DRAWINGS

Other features and advantages of the present invention will become apparent in the following detailed descriptions of the preferred embodiment with reference to the accompanying drawing.

FIG. 1 is a flow chart showing an embodiment of a method to find a best college fit;

FIG. 2 is a chart showing exemplary categories and attributes;

FIG. 3 is a flow chart showing an exemplary method to discover attributes;

FIG. 4 is a flow chart showing an embodiment of information flow;

FIG. 5 is an exemplary report showing valued attributes;

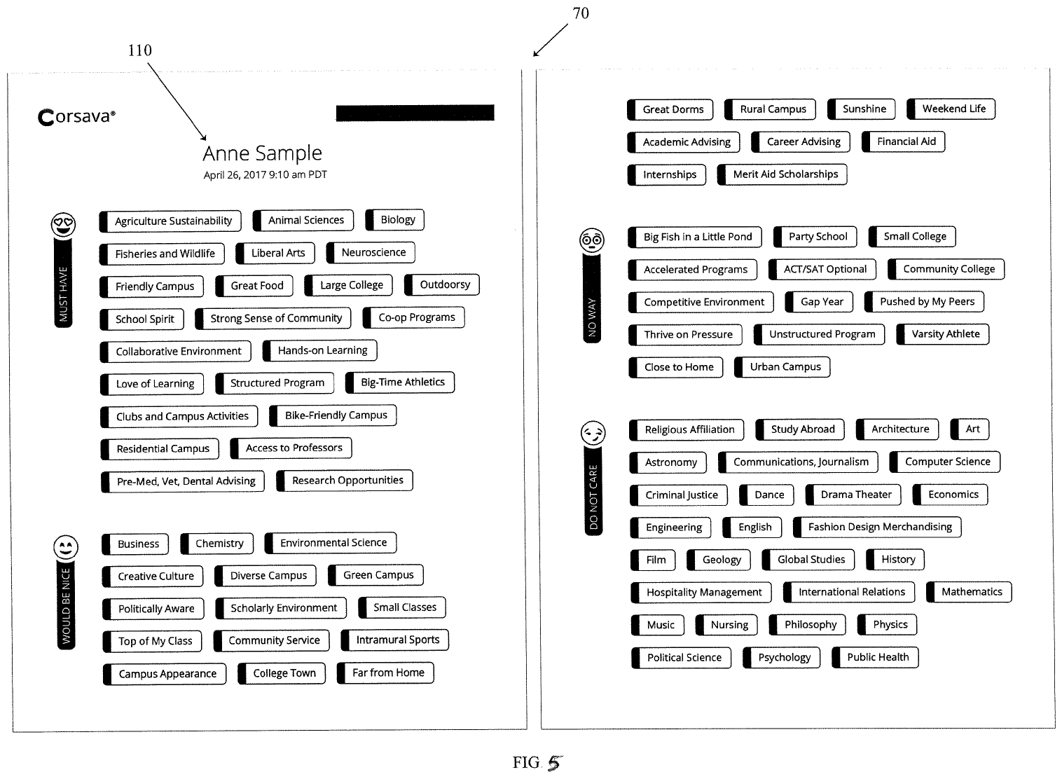

FIG. 6 is a flow chart showing an embodiment of the disclosed invention;

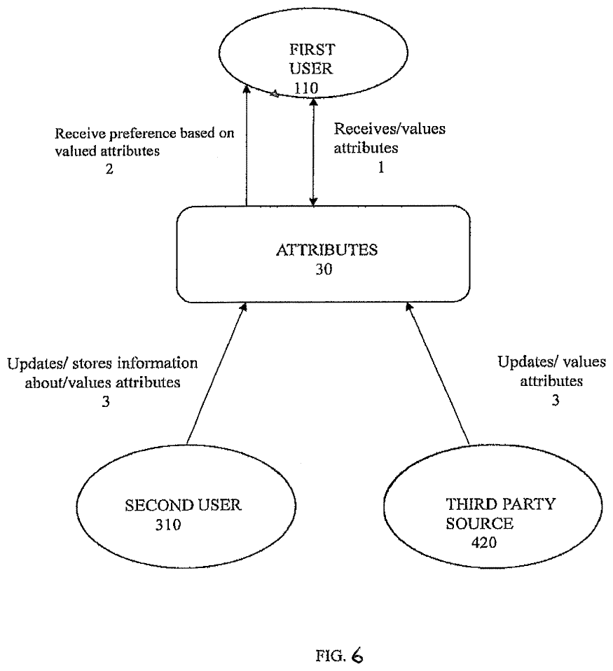

FIG. 7 is a flow chart showing an embodiment of the disclosed invention.

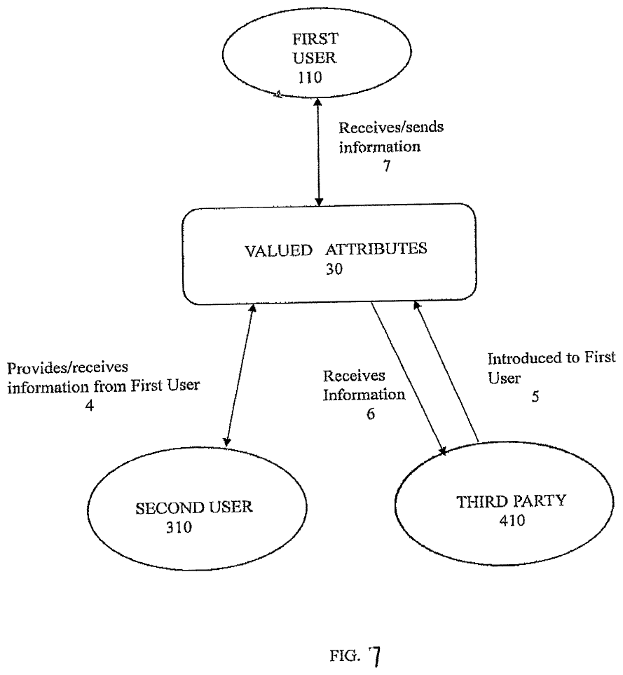

### DETAILED DESCRIPTION OF THE INVENTION

In the following detailed description, reference is made to the accompanying drawings, which form a part hereof. In the drawings, the use of similar or the same symbols in different drawings typically indicates similar or identical items, unless context dictates otherwise.

The illustrative embodiments described in the detailed description, drawings, and claims are not meant to be limiting. Other embodiments may be utilized, and other changes may be made, without departing from the spirit or scope of the subject matter presented here.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken as limiting.

The present application uses formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting. Given by way of overview, illustrative embodiments include system and method for determining the best college fit for an individual.

To reduce potential confusion, the following glossary provides general definitions of several frequently used terms within these specifications and claims with a view toward aiding in the comprehension of such terms. The definitions that follow should be regarded as providing accurate, but not exhaustive, meanings of the terms. Italicized words represent terms that are defined elsewhere in the glossary.

Attribute is a quality or feature of an educational institution. An attribute may be organized into categories.

Preference is subjective weight that a student gives to an attribute.

Impression or rating is the objective rating of an attribute.

Open-source data is data obtain from third party sources.

Metadata is data associated with impressions and attributes

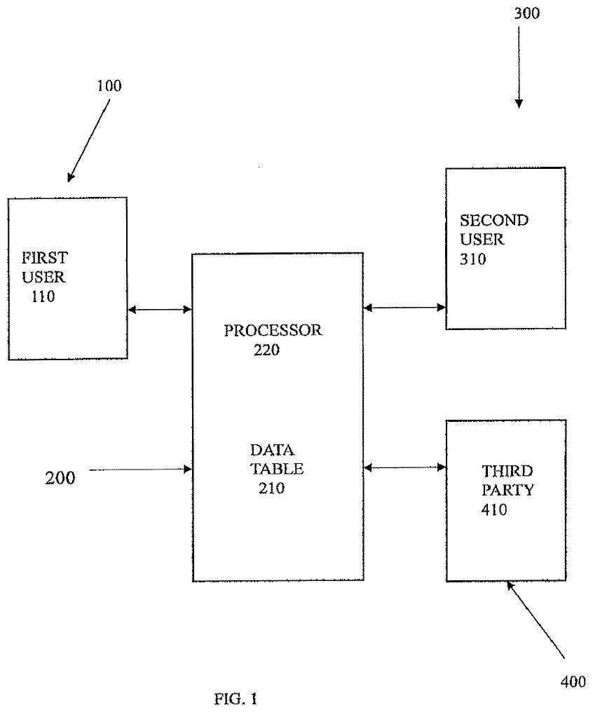

Referring to FIG. 1, a method to predict the best fit of a university, college, or other educational institution (200) is provided. (100) Although in this disclosure, system and methods are provided to find a “best college fit”, it will be obvious to a person having ordinary skill in the art that the same system and methods can be utilized to obtained the “worst college fit”.

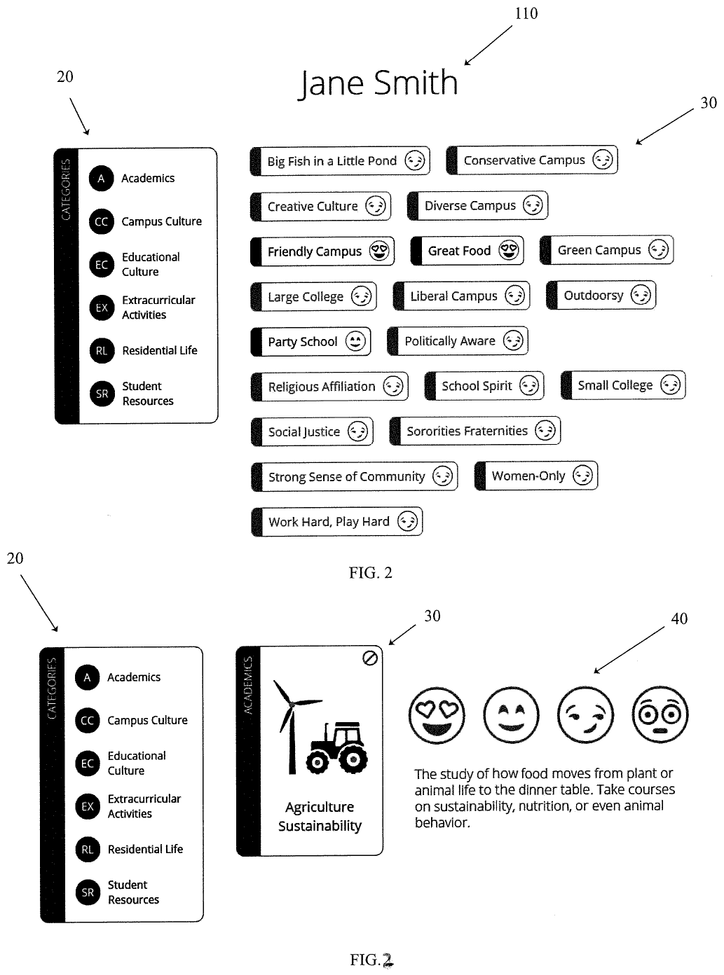

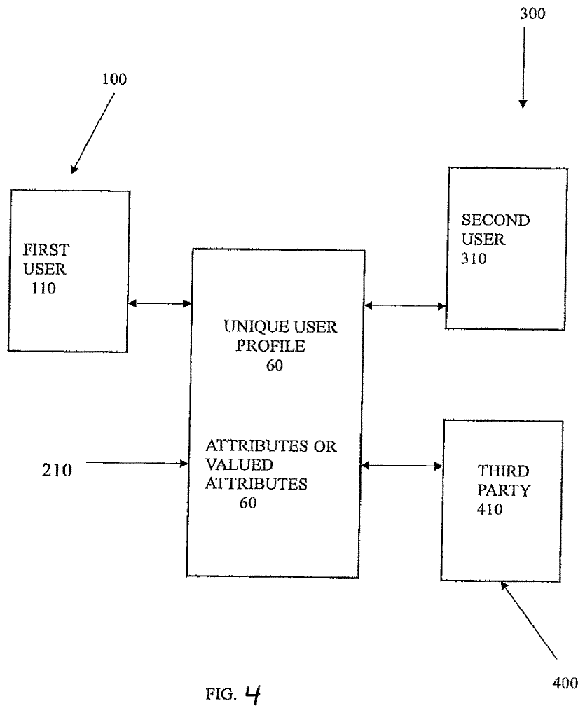

According to an embodiment, a student sorts (15) a plurality of weighted attributes (11), Referring to FIG. 4, according to an embodiment, attributes (10) may be organized by category (20). Categories (20) may include Academics, Campus Culture, Educational Culture, Extra Curricular Activities, Residential Life, Student Resource, amongst others. Referring to FIG. 2, according to an embodiment, attributes (10) for an educational institution (200) may be rated by subject matter experts (31), parents (32), and student (33), or other parties (e.g. public data bases, third-party literature, etc.) (34). A rating provides subjective and objective measure of an attribute (10). For example, a plurality of individuals may rate whether a campus has a diverse student body, an attribute (10). The plurality of ratings are used to weight the attribute for a particular educational institution (200). According to an embodiment,

Σw=1

Where w is a weighted attribute (11). The weighted attributes (11) are used to provide an educational institution (200) with an overall score (40) for a defined set of attributes (10). For example, the overall score (40) for one educational institution (200) having the attributes (10) of a diverse student body (w=0.3), being near the mountains (w=0.1), being near the water (w=0.4) and having an artificial intelligence program (w=0.2).

Referring to FIG. 1, According to an embodiment, a student may define his preferences (50) for an educational facility (200) that would be right for him. Referring to FIG. 4, a student may rate his preference for a diverse student body as a 0.2, being near the mountains as 0.1, being near the water as 0.3, and having an artificial intelligence program as 0.4 or a particular scale. Once the student completes rating her preference, a comparison of the student's preference (50) is compared to the overall score (40) of each educational institution (200). The student is then provided with a ranked list of educational institutions that best fit the student's preferences. For example, the University of Washington may be ranked first for the preferences defined above; while the University of New Hampshire may be ranked third.

In an embodiment, when preference (50) data is collected, meta-data (60) may also be collected. For example, social/family network, family financial status, social intelligence, educational background of parents, amongst others. The meta-data (60) may be used as supplemental preference (50) or weighted preferences (51) when determining the best college fit.

Referring to FIG. 1 once a ranked listing of educational institutional facilities (200) is provided to a student, she may accept or reject the recommendations. A rejected recommendation is considered an error (X) of a weighted attribute (11). According to an embodiment, the error may be used to calculate and objective function coefficient (c) such that:

ΣcX=w

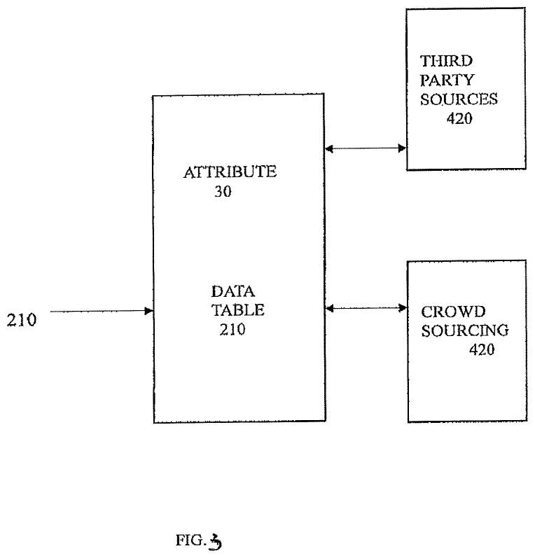

Referring to FIG. 3, that is, each time an error is detected for a weighted attributed (11) of an educational institution (200), the weighted attribute (11) is revised as described above.

Referring to FIGS. 1-4, in embodiments, the present invention may provide for a computer program product embodied in a computer readable medium that, when executing on one or more computers, provides a system and method to provide a first user (300) with at least one best fit educational institution (200) selected from a plurality of educational institutions (200) by performing the steps comprising: (1) receiving a request from a first user (300) for at least one attribute (10); (2) allowing the first user to rate the attribute (10); (3) store the first user's (300) rated attribute (11); (6) compare the value of the rate attributes (11) with an overall score provided to an educational institution (200); (7) provide the first user at least one best fit educational institution (200) based on the comparison of rated attributes (11) to overall score of an educational institution. A user may be a student, parent, counselor, or other third party.

Referring to FIGS. 1-4, in embodiments, the present invention may provide for a computer program product embodied in a computer readable medium that, when executing on one or more computers, provides a system and method to improve the prediction of a best fit educational institution (200) for a second-user comprising: (1) weighting a defined set of attributes (10) related to a plurality of educational institution (200); (2) provided each educational institution (200) in the plurality of educational institutions (200) an overall score (40) for the defined set of attributes (10); (3) allowing the first user to rate the defined set of attributes (10); (4) store the first user's (300) rated attribute (11); (5) compare the value of the first user's rated attributes (11) with an overall score (40) provided to each of the educational institution (200); (6) provide the first user at least one best fit educational institution (200) based on the comparison of rated attributes (11) to overall score of the educational institution (200); (8) allow the first user to accept or reject best college fit recommendation; (9) if the first-user rejects the best college fit recommendation, re-weight attributes based on rejection and calculate a revised overall score (41) for the educational institution (200); (10) allowing the second user to rate the defined set of attributes (10); (11) store the second user's (300) rated attribute (11); (12) compare the value of the second user's rated attributes (11) with the revised overall score (41); (13) provide the second user at least one best fit educational institution (200) based on the comparison of rated attributes (14) to the revised overall score (41) of the an educational institution (200). In one embodiment, revision of the overall score (41) of an educational institution (200) can be done in real time. In another embodiment, revision of the overall score (41) of an educational institution (200) can be done in batch mode. The computer program provides a better prediction of best college fit each instance the overall score (41) of an educational institution (200) is revised.

The different parameters used to predict the best institutional fit can be updated using the appropriate machine learning algorithms. For example, the weights can be treated as an optimization problem with the appropriate objective function. In another embodiment, the parameters can be directly or indirectly updated using a deep learning algorithm.

A user may be a student, parent, counselor, or other third party.

The methods and systems described herein may be deployed in part or in whole through a machine that executes computer software, program codes, and/or instructions on a processor. The present invention may be implemented as a method on a machine, as a system or apparatus as of or in relation to the machine, or as a computer program product embodied in computer readable medium executing on one or more of the machines. The processor may be part of a servicer, client, network infrastructure, mobile computing platform, stationary computing platform, or other computing platform. A processor may be any kind of computational or processing device capable of executing program instructions, codes, binary instructions and the like. The processor may be or includes a single processor, digital processor, embedded processor, microprocessor, or any variant such as a co-processor (math co-processor, graphic co-processor, communication co-processor and the like) and may directly or indirectly facilitate execution of multiple program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have been assigned priorities associated with them; the processor may execute these threads based on priority or any other order based on instructions provided in the program code. The processor may include memory that stores methods, codes, instructions and programs as described herein and elsewhere. The processor may access a storage medium associated with the processor to storing methods, programs, codes, program instructions or other types of instruction capable of being executed by the computing process device may include but may not be limited to one or more of CD-ROM, DVD, memory, hard disk, flash drive, RAM, ROM, cache, and the like.

A processor may include one or more cores that may enhance speed and performance of a multiprocessor. In embodiments, the processor may be a dual core processor, quad core processor, or other chip level multiprocessor and the like that combine two or more independent cores (called a die).

The methods and systems described herein may be deployed in part or in whole through a machine that executes computer software on a server, client, firewall, gateway, hub, router, or other such computer or networking hardware. The software program may be associated with a server that may include a file server, print server, domain server, internet server, intranet server, and other variant such as secondary server, host server, distributed server, and the like. The server may include one or more of memories, processors, computer communication devices, and interfaces capable of accessing other client servers, clients, machines, and devices through wired or wireless medium, and the like. The methods, programs or codes described herewith and elsewhere may be executed by the server. In addition, other devices required for execution of methods as described in this application as part of an infrastructure associated with the server.

The server may provide an interface to other devices including, without limitation, clients, other servers, printers, database servers, print servers, file servers, communication servers, distributed servers and the like. Additionally, this coupling and connection may facilitate remote execution of program across the network. The networking of some or all of these devices may facilitate parallel processing of a program or method at one or more locations without deviating from the scope of the invention. In addition, any of the devices attached to the server through an interface may include at least one storage medium capable of storing methods, programs, code and/or instructions to be executed on different devices. In this implementation, the remote repository may act as a storage medium for program code, instructions, and programs.

The software program may be associated with a client that may include a file client, print client, domain client, internet client, and other variants such as secondary clients, host clients, distributed clients and the like. The client may include one or more memories, processors, computer readable media, storage media, ports (physical and virtual). Communication devices, and interfaces capable of accessing other clients, servers, machines, and devices, and interfaces capable of accessing other clients, servers, machines, and devices, through a wired or wireless medium, and the like. The methods, programs or codes as described herein and elsewhere may be executed by the client. In addition, other devices required for execution of the methods as described herein this application may be considered as a part of the infrastructure associated with the client.

The client may provide an interface to other devices including without limitation, servers, other clients, printers, data based servers, file servers, communications servers, distributed servers and the like. Additionally, coupling and/or connection may facilitate remote execution of program across the network. The networking of some or all of the devices may facilitate parallel processing of a program or method at one or more locations without deviating from the scope of this invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The method and systems described herein may be deployed in part or in whole through network infrastructures. The network infrastructure may include elements such as computing devices, servers, routers, hubs, firewalls, clients, personal computers, communication devices, routing devices, and other active and passive devices, modules and/or components known in the art. The computing and or non-computing device(s) associated with the network infrastructure may include, apart from other components, a storage medium such as flash memory, buffer, stack, RAM, ROM, and the like. The processes, methods, program codes, instructions described herein and elsewhere may be executed by one or more of the network infrastructural elements. The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be GSM, GPRS, #G 4G, EVDO, mesh, or other network types.

The methods, programs, codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as a flash memory, buffer, RAM, ROM, and one or more computing devices. The computing devices associated with mobile devices maybe enabled to execute program codes, methods, and instructions stored thereon. Alternatively, the mobile device maybe configured to execute instructions in collaboration with other devices. The mobile devices may communicate on a peer to peer network. The program code maybe stored on the storage medium associated with the server and executed by a computing device embedded within the server. The base station may include a computing devices and a storage medium. The storage device may store program code and instructions executed by computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage such as optical discs, forms of magnetic storage, like hard disks, tapes, drums, cards, and other types; processor registers, cache memory, volatile memory, non-volatile memory, optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, network attached storage, file addressable, content addressable, network, barcodes, magnetic ink, and the like.

The methods and systems described herein may transform physical and/or intangible items from one state to another. The methods and systems or intangible items from one state to another. The methods and systems described herein may also transform data representing physical and/or intangible items from one state to another.

The elements described and depicted herein, including flow charts and block diagrams throughout the figures, imply logical boundaries between the elements. However, according to software or hardware engineering practices, the depicted elements and functions thereof may be implemented on machines through computer executable media having a processor capable of executing program instructions, as standalone software modules, or as modules that employ external routines, codes, services, and so forth, or any combination of these, and all such implementations maybe within the scope of the present disclosures. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps hereof, may be realized in hardware, software or any combination of hardware and software suitable for an application. The hardware may include a general-purpose computer and/or dedicated computing device or specific computing device or aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof. In another aspect, the methods may be embodied in systems that perform the steps thereof, and may be distributed across devices in several ways, or all the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

What is claimed:

1. A method for helping a first user select a preferred educational institution from a plurality of educational institutions implemented on a general-purpose computer with processor-executable program instructions configured to direct at least one processor and at least one data table including data useful for predictive analysis, for selecting or providing a predilection for at least one educational institution from a plurality of educational institutions comprised of:
receiving, by the processor, a request to provide, to a computing device associated with a first user, more than one attribute associated with at least one educational institution; whereby each provided attribute is weighted to describe an educational institution;
identifying, by the processor, more than attribute responsive to the request stored on the at the at least one data table;
providing, from the at least one data table, for a display on the computing device associated with the first user, the identified attributes;
allowing, by the processor, the first user to value the identified objective attributes;
storing, the first user's valued attributes on the at least one data table;
providing, for display on the computing device associated with the first user, the valued attributes or ranked valued attributes;
providing, for display on the computing device associated with the first user, at least one first preferred educational institution based on first user rated attributes;
allowing, by processor, the first user to accept or reject the first preferred educational institution;
allowing, by processor, the rejected educational institution to be considered an error used to calculate a coefficient of the attribute;
providing, for display on the computing device associated with the first user, at least a second preferred educational institution.

2. The method according to claim 1, further comprising providing, for display on a computing device associated with a second user, the valued attributes or ranked valued attributes of the first user.

3. The method according to claim 1, further comprises, allowing the first user, by the processor, to create a unique user profile; wherein the first user unique user profile is comprised of profile information which includes at least one member selected from a group consisting of: first user age, first user grade level, first user location, first user profile data of similar users, time of day the first user accesses the at least one stored stat table, social interaction of the first user, first user interests, first user preferred language, and first user demographic information.

4. The method according to claim 3, further comprising, allowing, by the processor, a second user to access the first user's unique user profile.

5. The method according to claim 4, further comprising, providing, for display on the computing device associated with the second user, the valued attributes or ranked valued attributes associated with the first user's unique user profile.

6. The method according to claim 5, further comprising, allowing, by the processor, the second user to deliver to the computing device associated with the first user a request that the first user value additional attributes or request additional information about a particular attribute.

7. The method according to claim 5, further allowing, by the processor, the second user to provide, for display on the computing device associated with the first user, information regarding at least one educational institution.

8. The method according to claim 5, further comprises, allowing, by the processor, the provided display on the computing device associated with the first user or a computing device associated with the second user, the rated attributes or valued rated attributes to be provided as a PDF and/or as a tokenized URL.
